(19) United States
(12) Patent Application Publication
(10) Pub. No.: US 2003/0000881 A1
(43) Pub. Date: Jan. 2, 2003

(54) Anti-cheating device for water filter

(76) Inventor: Shih-Ping Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/183,675

(22) Filed: Jun. 28, 2002

(30) Foreign Application Priority Data
Jun. 29, 2001 (TW) 09021887

(51) Int. Cl. B01D 27/00

(52) U.S. Cl. 210/233

(57) ABSTRACT

A water filter includes a casing in which active carbon, foam material or ceramic is received. An end cap is connected to the casing and an outlet is defined through the end cap. A removable member is connected to the end cap by a plurality of connection plates. The removable member has to be removed before the filter is installed and the connection plates are broken during removing the removable member.

### FIELD OF THE INVENTION

The present invention relates to a water filter that has a removable member connected to the outlet or inlet of the filter with several tiny connection plates connected therebetween which are broken before being used.

### BACKGROUND OF THE INVENTION

A conventional water filter generally includes a core which is made of active carbon, foam material, ultra-violet lamp or ceramic, and a casing which encloses the core. An end cap is connected to the casing so as to retain the core in the casing. Water may enter through the wall of the casing and the core to be filtered and the filtered water comes out from an outlet defined in the end cap. Another type of the water filter has two end caps and the casing is made of plastic or metal. An inlet and an outlet are respectively defined in the two end caps so that water enters in the casing via the inlet and the filtered water comes out from the outlet. However, none of the conventional water filters has proper device to allow the user to make sure that the water filter that he or she purchased is a genuine one.

The present invention intends to provide a water filter that has a removable member which is rotated before the filter is used and several connection plates are connected between the removable member and the filter so that the users can tell the status of the filter by checking the connection plates.

### SUMMARY OF THE INVENTION

In accordance with one aspect of the present invention, there is provided a water filter which includes a casing and an end cap is connected to the casing and an outlet is defined through the end cap. A removable member is connected to the end cap by a plurality of connection plates.

The primary object of the present invention is to provide a water filter that has an anti-cheating device which has to be broken before use and the user may check the anti-cheating device when purchasing the water filters.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1A is a perspective view to show the water filter of the present invention;

FIG. 1B shows the filter is received in a container;

FIG. 2 shows the water filter has an inlet in one end and an outlet in the other end, and the anti-cheating device is connected to the outlet;

FIG. 3 shows the water filter has a threaded rod and the anti-cheating device is connected to the threaded rod;

FIGS. 4A and 4B show another type of the anti-cheating device;

FIGS. 5A and 5B show yet another type of the anti-cheating device;

FIG. 5C shows the water filter as shown in FIGS. 5A and 5B used in a pot;

FIGS. 6A and 6B show the removable member is received in a recess of the core;

FIGS. 7A and 7B show another type of the anti-cheating device;

FIG. 7C shows the water filter as shown in FIGS. 7A and 7B used with a casing; and

FIG. 8 shows the filters connected with a water filtering system.

### DETAILED DESCRIPTION OF THE PREFERRED EMBODIMENT

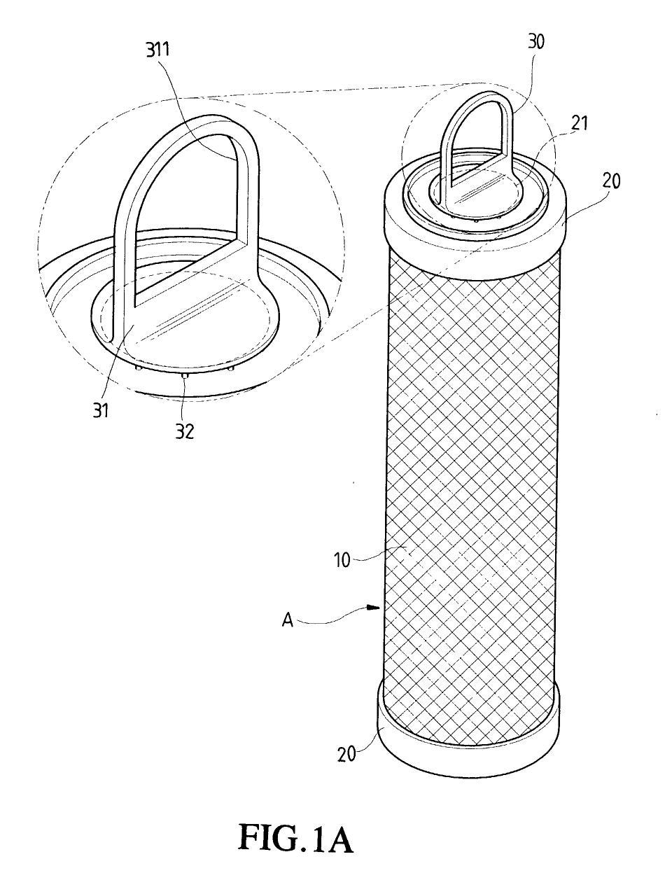

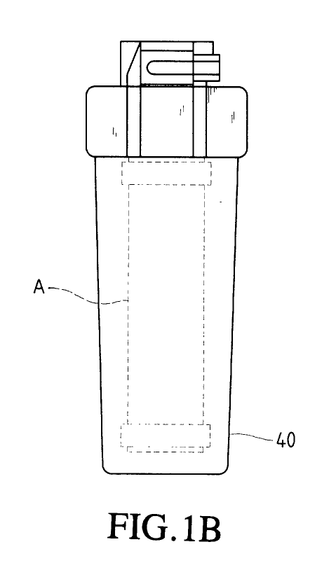

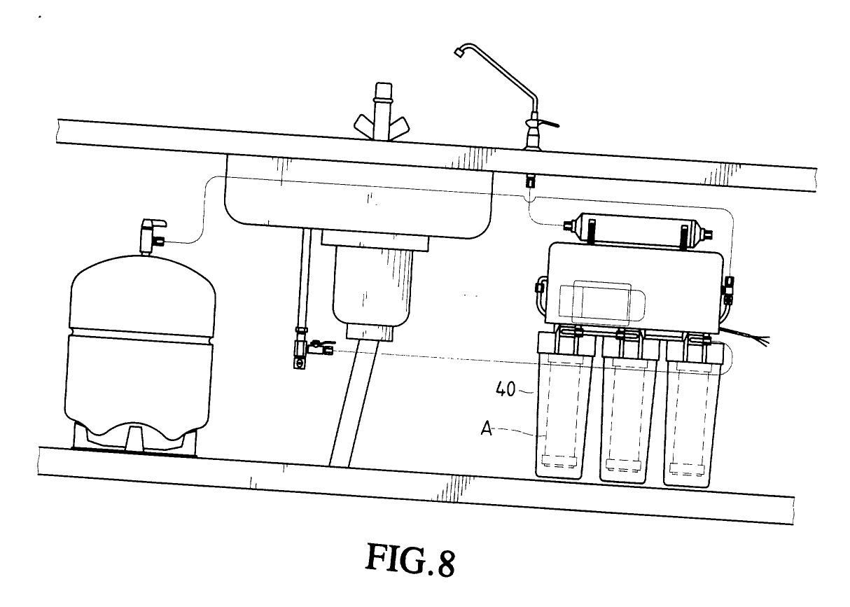

Referring to FIGS. 1B and 8, the water filter “A” of the present invention is received in a container 40 which is connected to a pipe of the water filtering system so as to filter the water passing through the water filter “A”. Referring to FIG. 1A, the water filter “A” comprises a casing 10 which has two ends and active carbon, foam material or ceramic is stuffed in the casing 10. An end cap 20 is connected to each of two ends of the casing 10 and an outlet 21 is defined through the end cap 20.

A removable member 30 is connected to the end cap 20 and seals the outlet 21. The removable member 30 is connected to the end cap 20 by a plurality of connection plates 32. The removable member 30 includes an upright plate 31 and a hole 311 is defined through the upright plate 31 so that the user may use a finger to engage the hole 311 to rotate the removable member 30. The water filter “A” can only be installed to the water filtering system by removing the removable member 30 and the connection plates 32 are broken during the removal of the removable member 30. By this way, the user can tell the water filter is a genuine one or not by checking the connection plates 32.

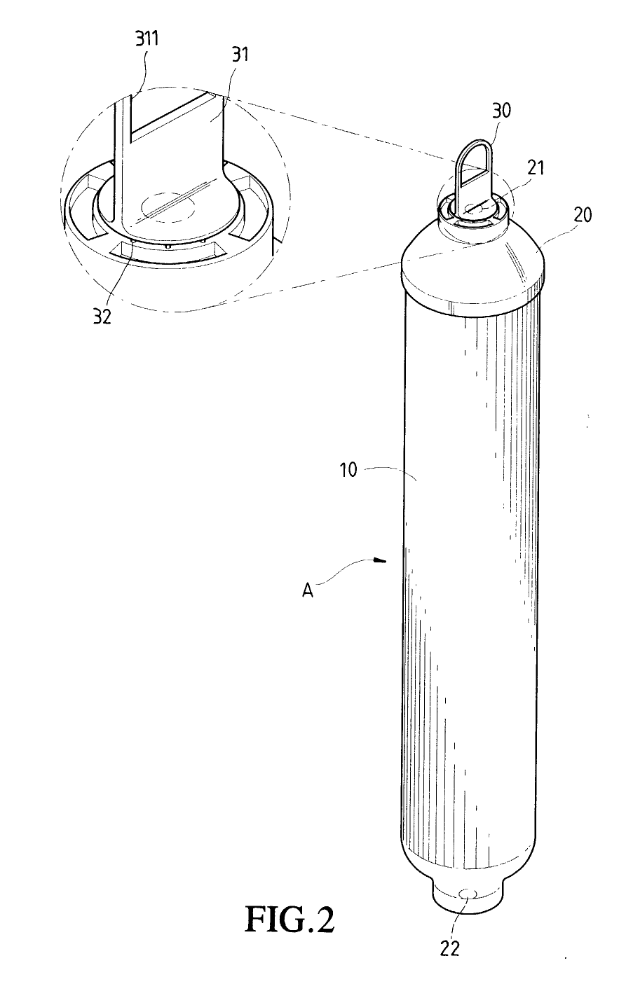

FIG. 2 shows another type of the water filter “A” wherein the casing 10 is an isolated casing 10 and water cannot enter through the casing 10. An inlet 22 is defined in the end cap at a first end of the filter “A” and an outlet 32 is defined through the end cap 20 at a second end of the filter “A”. The removable member 30 is connected to the outlet 21 and a plurality of the connection plates 32 are connected between the removable member 30 and the inner periphery of the outlet 21.

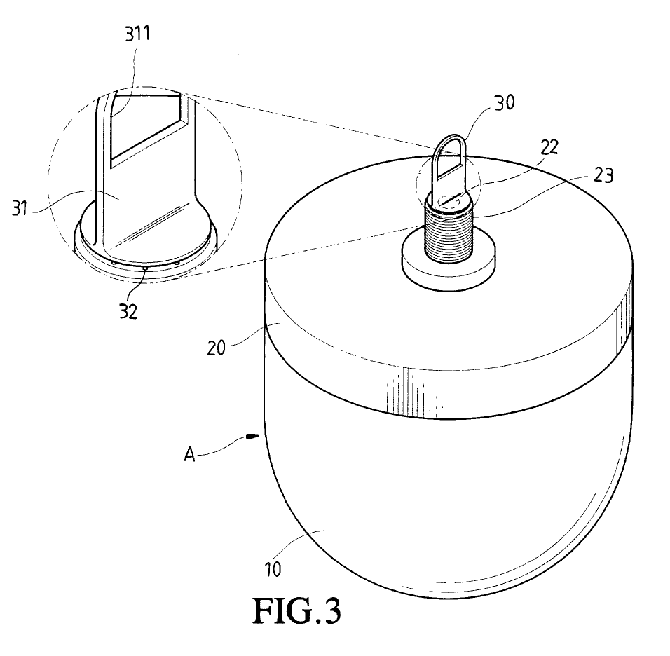

FIG. 3 shows the filter “A” is a ceramic filter and has a threaded rod 23 extending from an end thereof so as to be threadedly connected to the water filtering system and an inlet 22 is defined in the threaded rod 23. The removable member 30 is connected to the inlet 22 and a plurality of the connection plates 32 are connected between the removable member 30 and the inner periphery of the inlet 22.

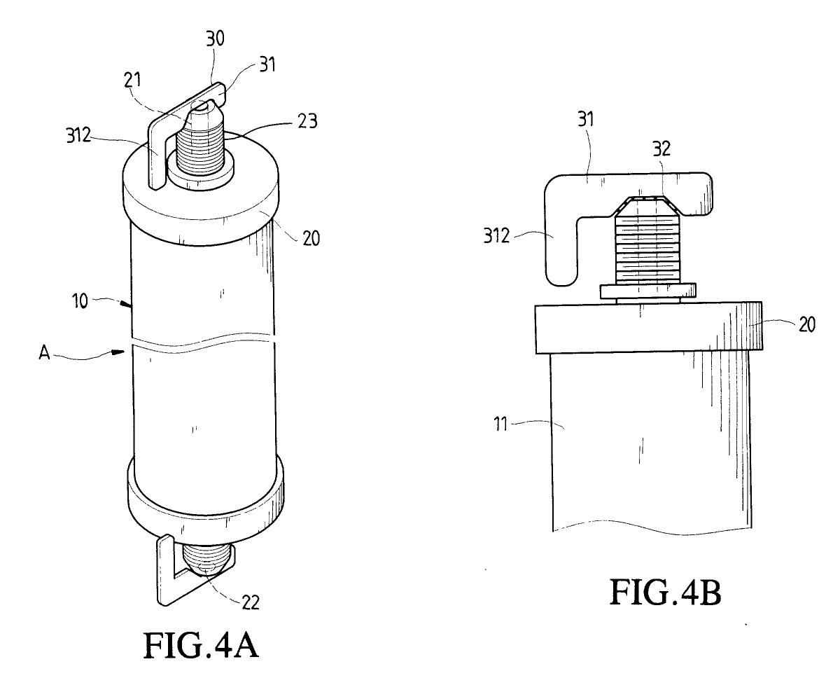

FIGS. 4A and 4B show that the removable member 30 can be an L-shaped plate and has a handle 312 and a body 31 which is connected to the threaded rod by the connection plates 32.

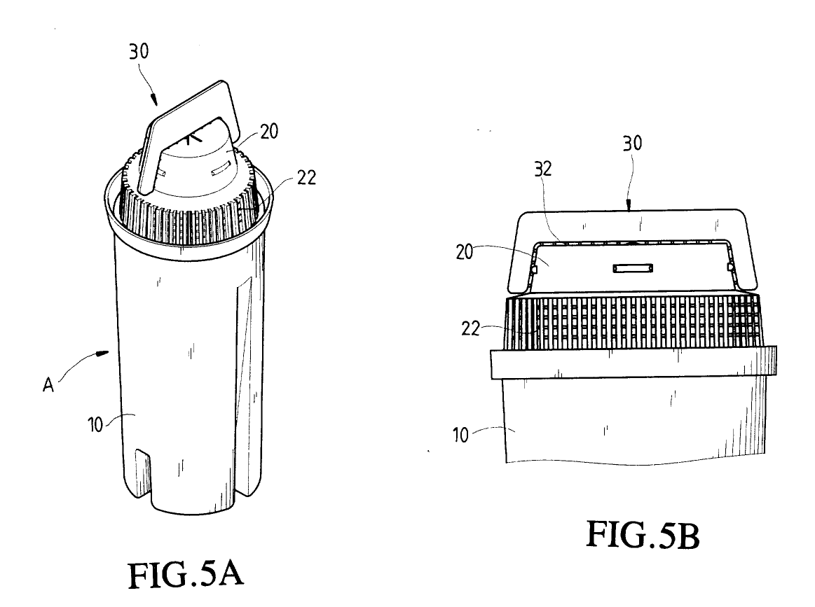

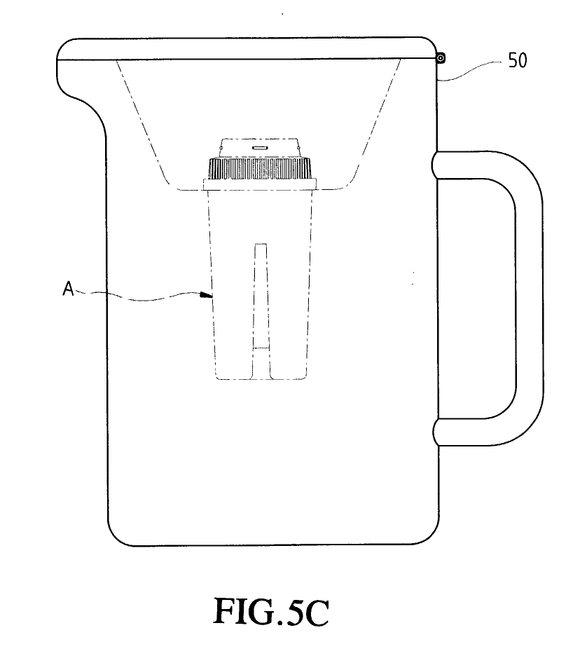

FIGS. 5A and 5B show the removable member 30 is a U-shaped plate and the filter “A” is installed in a pot 50 as shown in FIG. 5C and the inlet 22 is located at the outer periphery of the filter “A”.

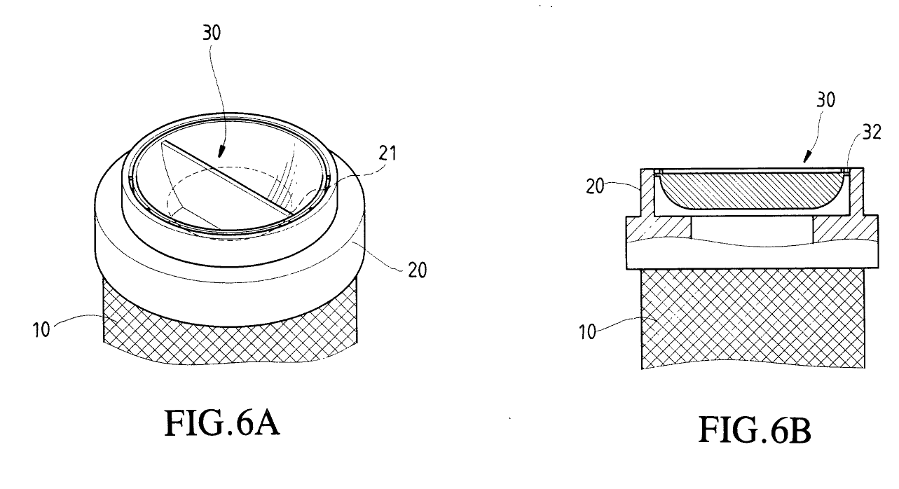

FIGS. 6A and 6B shows that the end cap 20 has a recess defined therein and the removable member 30 is received in the recess. The connection plates 32 are connected between the removable member 30 and an inside of the recess of the end cap 20.

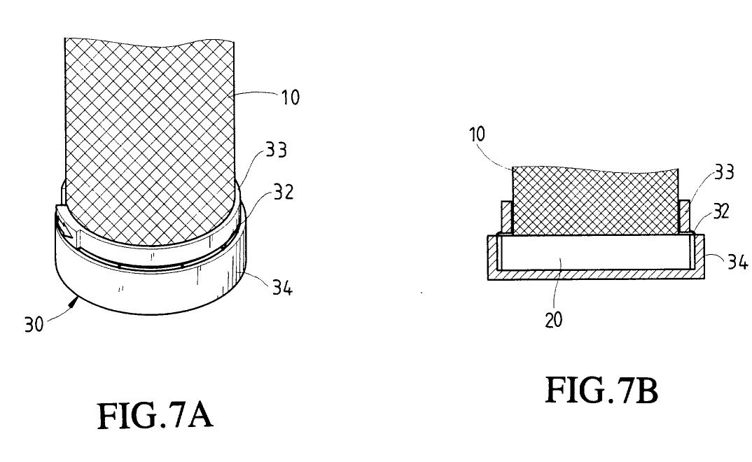

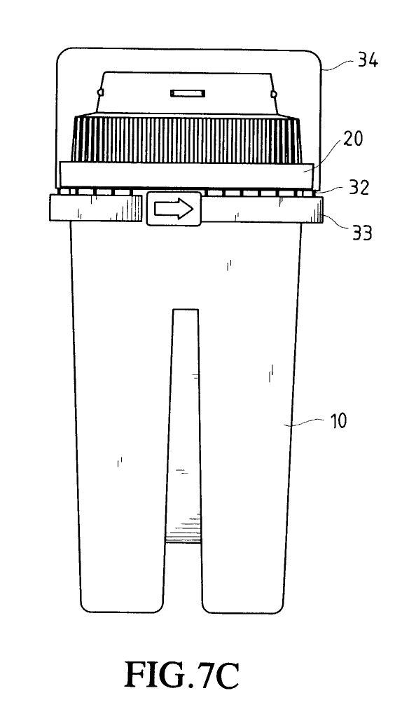

FIGS. 7A, 7B and 7C show that water filter includes a casing 10 and an end cap 20 is connected to the casing 10. An end cover 34 is mounted to the end cap 20 and a seal belt 33 is mounted to the casing 10. The seal belt 33 is connected to the end cover 34 by a plurality of connection plates 32.

The removable member 30 and the connection plates 32 perform as an anti-cheating device which allows the user to tell whether the water filter is a new one by checking the connection plates 32.

While we have shown and described the embodiment in accordance with the present invention, it should be clear to those skilled in the art that further embodiments may be made without departing from the scope of the present invention.

What is claimed is:

1. A water filter comprising:
a casing and an end cap connected to at least one of tow ends of the casing and an outlet defined through the end cap, and
a removable member connected to the end cap by a plurality of connection plates.

2. The water filter as claimed in claim 1, wherein the outlet defined through the end cap is sealed by the removable member.

3. The water filter as claimed in claim 1, wherein the end cap has a recess defined therein and the removable member is received in the recess, the connection plates connected between the removable member and an inside of the recess of the end cap.

4. The water filter as claimed in claim 1, wherein the removable member has a hole 311 defined therethrough.

5. A water filter comprising:
a casing and an end cap connected to at least one of tow ends of the casing, and
an end cover mounted to the end cap and a seal belt mounted to the casing and connected to the end cover by a plurality of connection plates.
